(19) United States
(12) Patent Application Publication
(10) Pub. No.: US 2002/0066017 A1
(43) Pub. Date: May 30, 2002

(54) Security systems for internet transactions and method of use

(75) Inventors: Winston Ser Tuen Wei, Singapore (SG); Wang Jia Ye, Singapore (SG); Sun Cheng Min, Singapore (SG); Eugene Ghe, Singapore (SG)

Correspondence Address: GREER, BURNS & CRAIN, LTD., 25th Floor, 300 South Wacker Drive, Chicago, IL, 60606, US

(73) Assignee: Multiscience System Pte Ltd.

(21) Appl. No.: 09/908,090

(22) Filed: Jul. 18, 2001

Related U.S. Application Data
(60) Provisional application No. 60/253,622, filed on Nov. 28, 2000.

(51) Int. Cl. H04L 9/00

(52) U.S. Cl. 713/170

(57) ABSTRACT

A security system and security method is provided for internet transactions for use in an electronic funds transfer environment and for confirmation of transactions over the internet. The system and method includes online processing of business transactions between at least one buyer, at least one seller, and at least one bank, where each user communicates via the internet and where each transaction incorporates use of a security key, said key comprising: code generated by a code engine independent of the buyer, the seller and the bank, said code being conveyed to the buyer by means independent of the internet, said code being supplied in machine readable format. The code is electronically verified by the seller and banker with the code engine before the transaction occurs.

### DESCRIPTION OF USE

This invention relates generally to the field of security applications for both financial and information transfer in internet applications. The security arrangements can be used between a plurality of types of buyers and one seller, a plurality of types of sellers and one buyer, and a combination of these.

The modern business market place generally includes a high degree of e-commerce. Such commerce can be either business to business (B2B) or business to end user. The B2B commerce can be at any point up and down a supply chain of services or commodities or a multiplicity of such supply chains. There are two principal difficulties with e-commerce with respect to billing transactions. These are, firstly, that with a plurality of different types of programs and different operating system bases, two business wishing to have a high degree of communication regarding billing may not have compatible programs. Secondly, the internet protocol (IP), which underlies much of the working of the internet, is a highly efficient and cost effective tool. However, this manner of operation, which provides this high efficiency and cost effectiveness, also leads to almost total lack of security regarding the information conveyed.

### BACKGROUND OF THE INVENTION

Initial attempts for providing security over the internet included application-level protocols and software. Examples of these included SSL for securing web traffic, SSH for securing Telnet sessions and file transfers, and PGP for securing email. However, these applications are all limited to specific programs or protocols. Thus where two businesses operate on different applications the systems may not be able to communicate effectively.

A number of different means of securely sending information on billing via the internet or electronic funds transfer have been proposed, with greater or lesser effectiveness.

U.S. Pat. No. 4,962,530 (Cairns) provides a system for randomly changing positions of indicia, which are represented by a matrix of keys from the keyboard. As this value randomly changes and is visible only to the sender the code is difficult to replicate without matching of stored values. However, for large interactive systems where a multiple number of end users or sellers are provided, this system is difficult to use efficiently and is slow to operate.

U.S. Pat. No. 4,799,156 (Shavit) discloses a systemfor interactive online communications and processing of business transactions, which involve different types of independent users and buyers and sellers. The system comprises access means for selective access to a database, which is centrally accessible, and in which one party uses the transaction to specifically select another party. However, the level of security is low and does not allow for easy transfer of payment instructions for accounts.

U.S. Pat. No. 4,396,914 (Aston) teaches an electronic security device with a memory and a card reader. What are now known as “smart cards” can be used with this device. However, every end user needs a card reader, if this is to be used in conjunction with e-business.

U.S. Pat. No. 4,271,482 (Giraud) provides a data processing system protecting confidentiality of key material. The security is provided by a predetermined permanent code key, which controls access to the computer or data after comparison to and recognition of the input code of the user. However, this system requires that the computer or device used and connected to the internet be used by the same user all the time. It is not possible for different computers or connection devices to be used by a multiplicity of users.

U.S. Pat. No. 4,234,932 (Gorgens) teaches a security system for remote cash dispensers. A PIN (personal identification number) generated by a random number signal generator, provides the security for an individual person to a remote terminal. The terminal can dispense cash and provide other banking services. However, such terminals are not connected to the internet; they do not provide the ability to conduct e-business with a multiplicity of retailers, only with one central banking system. It is not a system which could be used by a retail end user wishing to conduct e-business, as well as B2B commercial activity on the internet.

U.S. Pat. No. 4,630,201 (White) provides both on- and off-line transaction security systems using a code generated from the transaction and from a random number generator. However, this requires a portable transaction device and specialist cards, which are read by the portable transaction device. Thus the system cannot be used in an electronic B2B arrangement, nor with an electronic retailer and electronic business with a multiplicity of end users and internet interfaces.

U.S. Pat. No. 4,023,013 (Kinker) teaches online verification systems for identification of cards and the like. Once again however, a specialist card and card reader is required. Such readers are not generally available in B2B transactions and most retailers of the internet businesses do not have such card reader systems.

U.S. Pat. No. 6,097,307 (Utz) teaches a transmitting unit for a wireless security system, which incorporates randomised successive verification codes. This has specialist use when powering up an integrated circuit, incorporates a pseudo random number generator to warn against unauthorised entry into an automobile and such systems. The particular sequence of operations, which the system is designed to alert a user to, is not one that is generated during internet business transactions.

None of the prior art teaches a system that provides a security system usable for both B2B commercial transactions and e-business to retail commercial transactions. Further, none of the prior art teaches a system that can be used regardless of the different types of accounting systems of each business or retail buyer in a chain of electronic business.

It is an object to preserve the confidentiality of electronic transactions involving funds transfer in electronic business, without needing to be limited to a specific end user computer, specialist equipment for reading ‘smart cards’ or inputting encryption coding.

A further object of the invention is providing means for entering a code for identification or authentication, which means allows a secure comparison procedure to be performed electronically and to permit payment for products/services sold electronically, electronic transfer of funds, and electronic confirmation of all stages of the transaction.

It is an object of the present invention to address the foregoing problems or at least to provide the public with a useful choice.

### BRIEF DESCRIPTION OF THE INVENTION

According to this invention a security system is provided for internet transactions for use in an electronic funds transfer environment and for confirmation of transactions over the internet. The system includes online processing of business transactions between at least one buyer, at least one seller, and at least one bank, where each user communicates via the internet and where each transaction incorporates use of a security key, said key comprising: code generated by a code engine independent of the buyer, the seller and the bank, said code being conveyed to the buyer by means independent of the internet, said code being supplied in machine readable format.

The machine-readable format of the code is selected from the group: a disk capable of insertion in a portable media drive of a computer; a card with the information stored thereon in a ‘read-only’ format; a card with the information stored thereon in a ‘rewritable’ format; and a combination thereof. Optionally the portable media drive is the “‘A’ drive” of a computer.

The information is stored on a ‘magnetic card’ when stored as “read only” information or rewritable information.

If a disk, inserted in the A drive of a computer, is used for a transaction, the code contained on the disk is read by the security system operable when a transaction is occurring.

The ‘A’ drive is the usual name accorded the disk reader of a computer. It will be appreciated that this drive may be mapped with an alternative letter on a computer.

The code on the disk permits a central server or engine to authenticate the code and confirm this with the software of the seller and any bank involved. The code, when later used to confirm the transfer of funds for payment, can also be used to update the records of the buyer with the bank, and to update the records with the seller for the generation of billing.

In accordance with this invention the machine readable disk may be of the standard type of 3¼ inch disk that can be easily carried in a pocket, bag, etc, and is personal to the buyer, not limited to the computer or internet connection on which the buyer is conducting the transaction.

The code on the disk may be of many types and may involve one or more elements. Each time the code is used one or more elements may be changed. For example, to create starting codes for a user, four random numbers may be generated. Two of these numbers can be five digit numbers which can be merged to a ten digit number as a user starting code. With this number and the code, every user is assigned three numbers or parameters that are used for modifying the user code. The three parameters vary from user to user.

When a user uses the system, the code of the user is modified. The modification will be in two parts; one part for a significant change and another part to avoid repetition.

The code in each disk for each user is made up of a string of code and additional dummy codes and scrambled or encrypted into a key or code. The encryption is only accessible and readable by the code engine. A code of 10 kb in data size is preferable for ease of speed of reading and life span of the disk.

The code is on the disk in a language preferably selected from: JavaScript, active X, and visual basic script. The language used by the code engine (on the server side) includes, for example: C++ language to a COM component; or JavaScript or active server page.

In addition to this the disk can be monitored for unauthorised duplication. For example, if the code on the disk is being duplicated to (for example, 10 copies) once one of the duplicated disks or the original disk is being used for any transaction, a new code will be rewritten within the original disk for the next transaction. This rewritten code becomes the valid code. Thus the remaining 9 copies, which include the original code of the original disk, will be voided and invalidated for any subsequent use with the code engine.

Additionally, as another example, limits can be set within the code for copying of the code, so that after a set number of copies (for example, 9) the original and all further copies may be voided and invalidated for use.

Appropriate monitoring, of known type, at the code engine site can also be used to ascertain whether invalid disks with duplicate codes are being used. The transaction can be invalidated or provide an audit trail for forwarding to appropriate authorities.

In accordance with this invention the security system may further include a password-based user identification system, operable through the internet interfaces, which may be further used to identify a buyer to the system. The password as used herein is a string of symbols, which are used to authenticate an identity as additional to, or part of, the above security system.

An alternative to a password can be a system whereby the user controls the validation process by allowing the user to set personal security levels or on or off controls to activate or deactivate validation processes in conjunction with the valid code on the disk.

Such controls can be used for other purposes as well, for example, to inactivate the code for a period of time when aspects of the user's system will not be in operation (for example, inactivating a credit card for use for internet transactions).

The present invention departs from previously disclosed and known systems as it provides an independent path for providing a secure code to an end user for electronic business, and also provides a system that an end user can use on any computer or interface means with the internet where there is a system for machine reading disks.

In accordance with this invention the system as described above may be further used in a number of variations and modifications. With appropriate programming, the system may be used to assemble and compile a number of electronic billings generated by the one end user with the same seller, or a multiplicity of sellers, to generate one electronic account payable by the buyer. The system, by the use of the code on the disk, can also be operated for electronic transfer of funds from the buyer's bank to the seller, or sellers, to meet an account.

### BRIEF DESCRIPTION OF THE DRAWINGS

The present invention can more fully be understood by reference to the following detailed description and accompanying drawings, which form an integral part of the application.

FIG. 1 is a pictorial representation of the flow system using the security system of the present invention; and

FIG. 2 is a pictorial view of an application of the security system of the present invention in a real time setting of a library.

### DETAILED DESCRIPTION

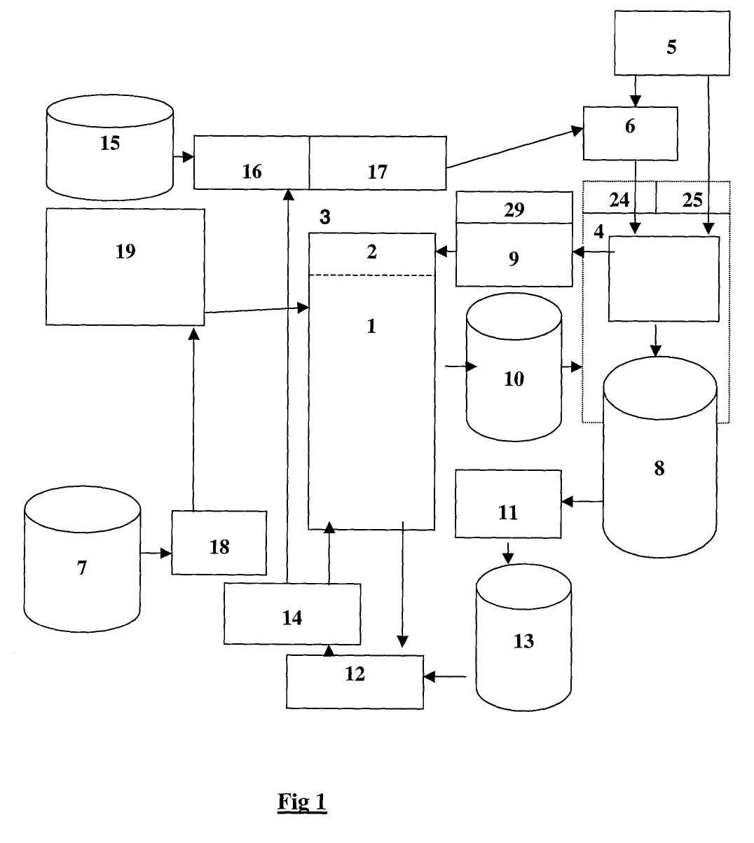

FIG. 1 illustrates the system in accordance with the invention. A portal server 1 incorporates an electronic engine 2 for the generation and checking of codes. The engine 2 incorporates appropriate software for identifying and reading codes forwarded electronically to it, or to the portal, and for identifying such codes and providing code authentication. The portal 1 and the engine 2 form part of the internet or web 3, which can be connected to by one or more PCs 4 representing the computer being used by one or more end users 5. Each user 5 has a disk with a code 6 thereon. Each user 5 has received the code 6 after application to the service provider operating the portal 1 and engine 2.

The disk with code 6 is forwarded to the user 5 by non-electronic means, after application by the user 5 for such a code 6. The user 5 may be an end retailer, or e-retailer. The user 5 may be a business in a supply chain who is placing orders for goods electronically in a B2B situation. Whilst the method of connection to the internet 3 has been represented as PC computer 4, it will be appreciated that any other form of internet connection, with means for machine reading of disks, may be used without departing from the scope of the invention.

The code 6 may be copy-protected by a number of means before being forwarded to the user 5. In addition to this the disk can be monitored for unauthorised duplication. For example, if the code 6 on the disk is being duplicated to (for example) ten copies, once one of the duplicated disks or the original disk is used for any transaction, a new code will be rewritten within the original disk for the next transaction. This rewritten code becomes the valid code 6. Thus the remaining nine copies, which include the original code of the original disk, will be voided and invalidated for any subsequent use with the code engine 2.

As an alternative, and if so desired, the disk with code 6 is incorporated with safe guards that erase the original after a specified number of times the disk has been copied—for example, nine times.

In addition to this security measure, the portal 1 and engine 2 can incorporate programming for comparison in order to ascertain whether or not two different people are using the same codes, the code having been copied. In the event that a copied code is used the portal 1 and engine 2 are pre-programmed such that an audit trail can be monitored or reproduced if needed by the appropriate authorities.

As an example of the operation of the invention: the user 5 selects and places an order with an e-commerce seller 7. The company 7 advises the user 5 of the billing requirements and asks for code authorisation and authentication. The user 5 provides this to the engine 2 by a code handshake and authentication (9, 10). The engine 2 will only provide code authentication 10 if the code 6 is present in the ‘A’ drive of PC 4 of the user 5. Once the code authentication 10 is provided the user 5 can also provide authorisation for payment. The ability to effect payment requires an electronic query by the bank 12 in question, who also use code authentication 13 for payment status 14. This payment is cleared through the banking system via route (13 and 14) as shown on FIG. 1. The user 5 can verify billing, selection and settlement 8 and payment status 11 during code verification 13.

The portal 1 and engine 2 are preferably operated by an independent administrator or business 15. The codes 6, on disks, can be issued on individual application to the business 15.

Alternatively the business 15 can bulk issue codes on disks to an appropriate further business 17 (which may be a bank 12). With appropriate backups for example an escrow agent 16, the system can be varied as is required by the businesses 7, banks 12 and users 5, or a combination thereof.

It will be appreciated that with the use of an independent body 15 a multiple number of computing companies in the same field (for example the banking industry) would be able to use the system of codes 6 with confidence.

Each company 7, when electronically billing, can generate billings and records of other transactions 18, which are then collated and/or consolidated 19 for each user 5. These collated transactions 19 are forwarded via portal 1 to either the bank 12 or end user 5, as directed. The user 5 can instruct the relative bank 12 by use of the code 6 to pay the account, or have standing instructions to the bank 12. The bank 12 uses the code authentication 13, payment status 12, and payment clearance 14 query to transfer funds to meet the account.

The portal 1 and engine 2 can be programmed to permit an additional layer of security. For example a password could be used to further authenticate the access of the user 5. Such coding could be used in addition to or as a temporary replacement for the code 6 on the disk if it were, for example, lost or misplaced.

A further, additional layer of security can optionally be added. This can be separate from the code 6 on a disk and with or without any password as described above. The control of such system would still lie with the user 5 of the disk. The additional layer of security would be a ‘flag control’ 29 operable by the user 5. Such flag control 29 can be used by the user 5 to activate or deactivate a validation process such that the code 6 on the disk and or password are secondary validation procedures.

Examples of the operation of such control can include, for example, the deactivation of a particular style of transaction 18 by the user 5; for example: credit card or mobile phone 24 for a specified period of time or indefinitely.

This can be of a advantage if a credit card is used on the internet and then the card is lost as it will prevent anyone illegally using the credit card of the user 5 for any transaction 18 on the internet.

Methods of setting such controls can include but are not limited to:

a stipulated SMS message incorporating the valid password to set the control and record it through the portal 1 with the engine 2;

a phone call using an automated keypad 25 answering service to note the user 5 and password via the keypad 25 before setting this control;

via the internet using SSL encryption and the valid ID and password to log in and activate the control page through the portal 1 and engine 2, to set the control; and

other communication media that can link to the internet and include keypads 25 and alpha numeric pads (including, for example, other WAP applications).

Key Generation Model Algorithm

The code 6 is generated in, for example, ten digits with a unique number for each of every 100,000 users 5. Every time a user 5 uses the invention the code is modified. The starting code 6 for each user 5 is four random numbers. From the four random numbers two numbers, each of which are five digit, are merged to create a ten digit number. With this number every user 5 is assigned three numbers or parameters that are used for modifying the starting code 6. The parameters are different for each user 5. As the user 5 uses the invention, the code 6 must be modified. It is obvious that a different number is required and that this number is not often repeated. To achieve this two of the three parameters operate to change the code. One of the parameters is for a significant change and the another parameter is to avoid repetitions. Thus each of the parameters rotates to generate different numbers within the numeric code 6.

The code 6 on the disk is comprised of the actual string of code and additional dummy codes which are scrambled or encrypted. The actual string of code 6 is broken up to seven sub-strings before being scrambled with those generated dummy codes, to form a code of approximately 10 kb in data size. It is not desirable to have the size of the code any larger than this, as reading it would otherwise take too much time.

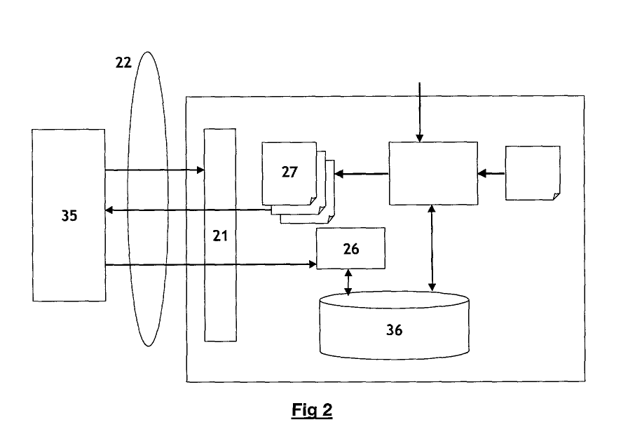

Referring to FIG. 2, the real time example given for the operation of the system described with reference to FIG. 1 is the operation of a library with a web-server 21, and in relation to customers 35 wishing to read from a selection of e-books held on a master database 36. Customers 35 query through the internet 22 and web-server 21 those books they wish to read or view. These books can be electronically downloaded as HTML pages 27 from the master database 36. The system can query the customer 35 for code for verification (which uses the disk and code 6 of FIG. 1) and the charge for the download recorded in the payment manager 26.

It will be understood that by appropriate regular billing, the individual charges recorded by the payment manager 26 can be itemised on an electronic account and forwarded to the customer 35. Via the system outlined in FIG. 1, the customer 35 may review the account and authorise the payment through his or her bank 12 with the aid of the code 6 on their personal disk.

Whilst the above described system has been discussed with use of the internet, it will be appreciated that this could also incorporate an intranet, and input means can be any connecting means capable of connection to the Internet an incorporating an ‘A’ drive.

Aspects of the present invention have been described by way of examples and it should be appreciated that the concept and principals of the system described are most important but also that modifications and additions may be made thereto without departing from the scope thereof.

1. A security system for internet transactions, for use in electronic funds transfer and for confirmation of transactions over the internet, said system including online processing of business transactions between users, said users including: at least one buyer, at least one seller, and at least one bank, wherein each user communicates with another user via the internet and wherein each transaction incorporates use of a unique security key, characterised in that said system incorporates computer processor and memory means for generating each key, said key comprising code generated by a code engine of the system, which engine is independent of said at least one buyer, said at least one seller and said at least one bank, said code being conveyed to said buyer by means independent of the internet, said code being supplied in machine readable format and verifiable by the code engine on electronic application of another user to the engine.

2. A security system for internet transactions as claimed in claim 1 wherein the machine-readable format of the code is selected from the group: a disk capable of insertion in a portable media drive of a computer; a card with the information stored thereon in a magnetic, ‘read-only’ format; a card with the information stored thereon in a magnetic ‘rewritable’ format; and a combination thereof.

3. A security system for internet transactions as claimed in claim 2 wherein the portable media drive is the “‘A’ drive” of a computer.

4. A security system for internet transactions as claimed in claim 1 wherein said key for each user is comprised of:
randomly generated numbers, of which at least two numbers are five digit numbers capable of combination to a ten digit number, which number operates as an initial code;
three parameters, two of which are operable to change the initial code and one of which is operable to avoid repetitions of the same 10 digit number when said number is changed.

5. A security system for internet transactions as claimed in either claim 1 or claim 4 wherein said security key is comprised of a string of written computer program language, which incorporates at least one false code, said program code is encrypted in a form only readable by said code engine.

6. A security system for internet transactions as claimed in claim 5 wherein said security key when encrypted is contained in less than or equal to 10 kb of data.

7. A security system for internet transactions as claimed in claim 4 wherein said three parameters also operate to limit the number of electronic replications of said code to a set, pre-determined number, after which any attempted replication does not generated an exact replication.

8. A security system for internet transactions as claimed in claim 5 wherein said computer program language is selected from the group: JavaScript, active X, visual basic script.

9. A security system for internet transactions as claimed in claim 1 wherein said code engine operates in a computer programming language which is selected form the group: C++; JavaScript and active server page.

10. A security system for internet transactions as claimed in claim 1 wherein said system further includes an additional password-based user-identification which is totally electronically based, which additional password includes an alphanumeric string to confirm the identity of a user by the code engine of the system.

11. A method of confirming the unique identity of a user in an internet transaction, said transaction including electronic funds transfer and confirmation of transactions over the internet, said users including at least one buyer, at least one seller and at least one bank; wherein each user communicates with another via the internet and wherein each transaction incorporates the use of a unique security key, characterised in that the method includes:
providing a security system incorporating computer processor and memory means on which is operated a code engine generating said codes;
on application by a user, providing a unique code to the user from the engine, said code being conveyed to the buyer by means independent of the internet, said code being in a machine readable format; whereby any buyer provides the code to said at least one seller and said at least one bank, upon request for verification for effecting completion of a transaction; and
said at least one seller and said at least one bank electronically confirm veracity of said code with said engine before a transaction occurs.

12. A method of confirming the unique identity of a user in an internet transaction, as claimed in claim 11 wherein said method further includes provision of the code in machine readable format selected from the group: a disk capable of insertion in the ‘A’ drive of a computer; a card with the information stored thereon in a magnetic, ‘read-only’ format; a card with the information stored thereon in a magnetic ‘rewritable’ format; and a combination thereof.

13. A method of confirming the unique identity of a user in an internet transaction, as claimed in claim 11 wherein said key for each user is comprised of:
randomly generated numbers, of which at least two numbers are five digit numbers capable of combination to a ten digit number, which number operates as an initial code;
three parameters, two of which are operable to change the initial code and one of which is operable to avoid repetitions of the same 10 digit number when said number is changed.

14. A method of confirming the unique identity of a user in an internet transaction, as claimed in claim 11 wherein said security key is comprised of a string of written computer program language, which incorporates at least one false code, said program code is encrypted in a form only readable by said code engine.

15. A method of confirming the unique identity of a user in an internet transaction, as claimed in claim 11 wherein said code engine, computer processor and memory means are controlled and maintained by an entity which is independent of the following: each user; each bank; any internet service providers; and telephonic service providers.
